(19) United States
(12) Patent Application Publication
(10) Pub. No.: US 2018/0050966 A1
(43) Pub. Date: Feb. 22, 2018

(54) SYSTEM AND METHOD FOR PRODUCING ORGANIC FERTILIZER

(71) Applicant: Ray Davy, Baker, WV (US)

(72) Inventor: Ray Davy, Baker, WV (US)

(21) Appl. No.: 15/242,750

(22) Filed: Aug. 22, 2016

(51) Int. Cl. C05F 3/00; C05G 3/00; C05F 3/06; C02F 1/00; C02F 1/38; B01D 21/26; B01D 36/04

(52) U.S. Cl. CPC C05F 3/00; C05G 3/0064; C05F 3/06; C02F 2103/20; C02F 1/385; B01D 21/262; B01D 36/045; C02F 1/004

(57) ABSTRACT

A method for producing organic fertilizer from poultry litter is provided. The method may include: providing one or more samples of poultry litter; mixing the samples of poultry litter with water; centrifuging the mixture of the water and the samples to separate the mixture into a liquid component and a solid component; and filtering a resulting mixture of the water and the samples to form an organic fertilizer.

### CROSS-REFERENCES TO RELATED APPLICATIONS

N/A.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

The present disclosure generally relates to the field of producing organic fertilizer from fresh poultry litter and, more specifically, to an organic fertilizer and method for producing the organic fertilizer from fresh poultry litter wherein the organic fertilizers lacks any weed or seed.

### DESCRIPTION OF THE RELATED ART

Poultry farming involves raising domesticated birds like chicken, turkey, and ducks etc. It not only generates very good income but also provides the necessary source of protein rich products including eggs and meat for food. The commercial level poultry farming at large farms has, however, also raised environmental concerns as effective waste management for large scale poultry farming is critical for safe environment.

One way of managing the poultry waste is to directly apply it to the ground serving as manure for plant nutrition. However, the direct application of poultry litter as manure to the ground causes major environmental concerns. These poultry litter generally contains seeds and when applied to the ground as manure cause weed generation on the crop producing field. This weed growth then needs application of costly and soil polluting weedicides.

Furthermore, pollutants present in these poultry litter based manure runoff with rainwater into surface and ground waters. As a result, the waters are unsuitable for drinking. It also causes emissions of greenhouse gases to the atmosphere. Fresh poultry litter is bulky, smelly, have low nutrient concentrations, have irregular shapes, and require special equipment for fertilizer application.

Therefore, what is needed is a system and method for producing an organic fertilizer from the poultry litter which provides good plant nutrition when applied to the crop field.

### SUMMARY

In an embodiment, a system for producing organic fertilizer from poultry litter is provided. The system may include: a sample providing device to provide one or more samples of poultry litter; a mixer to mix the samples of poultry litter with water; a centrifuge device to centrifuge the mixture of the water and the samples to separate the mixture into a liquid component and a solid component; and a filter for filtering a resulting mixture of the water and the samples to form an organic fertilizer.

In another embodiment, a method for producing organic fertilizer from poultry litter is provided. The method may include: providing one or more samples of poultry litter; mixing the samples of poultry litter with water; centrifuging the mixture of the water and the samples to separate the mixture into a liquid component and a solid component; and filtering a resulting mixture of the water and the samples to form an organic fertilizer.

In yet another embodiment, an apparatus for producing organic fertilizer from poultry litter is provided. The apparatus may include: a data analyzing device to analyze one or more samples of poultry litter; a mixer to mix the samples of poultry litter with water; a centrifuge device to centrifuge the mixture of the water and the samples to separate the mixture into a liquid component and a solid component; and a filter for filtering a resulting mixture of the water and the samples to form an organic fertilizer.

In still another embodiment, a means for producing organic fertilizer from poultry litter is provided. The means may include: a means for analyzing one or more samples of poultry litter; a means for mixing the samples of poultry litter with water; a means for centrifuging the mixture of the water and the samples; and a means for filtering a resulting mixture of the water and the samples.

### BRIEF DESCRIPTION OF THE DRAWINGS

The present invention is described in detail below with reference to the attached drawing figures, which are incorporated by reference herein and wherein:

FIG. 1A is a block diagram illustrating an exemplary embodiment of the invention;

FIG. 1B is a block diagram with data samples in accordance with an exemplary embodiment of the invention;

FIG. 2 is a block diagram of a computer that may be connected to the network; and

FIG. 3 is a flowchart illustrating a process in accordance with exemplary embodiments of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the exemplary embodiments of the invention, further discussion of such software and ICs, if any, will be limited to the essentials with respect to the principles and concepts of the preferred embodiments.

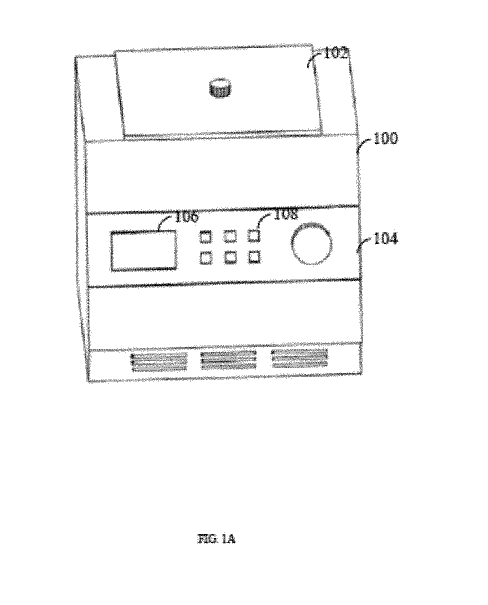

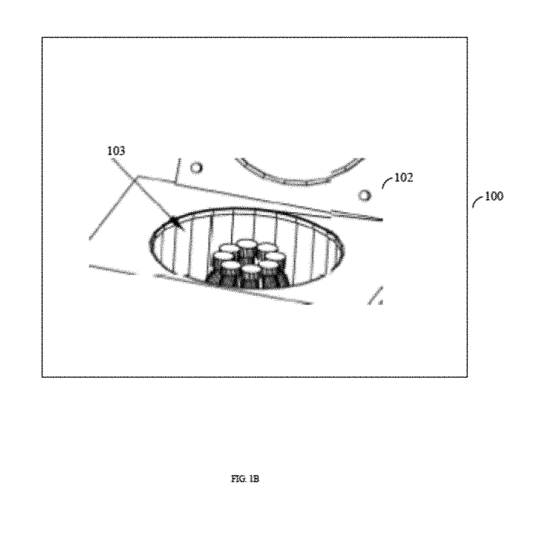

FIGS. 1A and 1B illustrate a block diagram 100 in accordance with exemplary embodiments of the invention. As shown in FIG. 1A, the device 100 may include a hinge door 102 for inserting samples (not shown) and a panel 104 with a display 106 and buttons 108 for operating the device 100. In some implementations, the device 100 may be a centrifuge, a data analyzing lab instrument, or any sample analyzing device known to those skilled in the art. As shown in FIG. 1B, the samples 103 may be inserted in the device 100 when the hinge door 102 is opened.

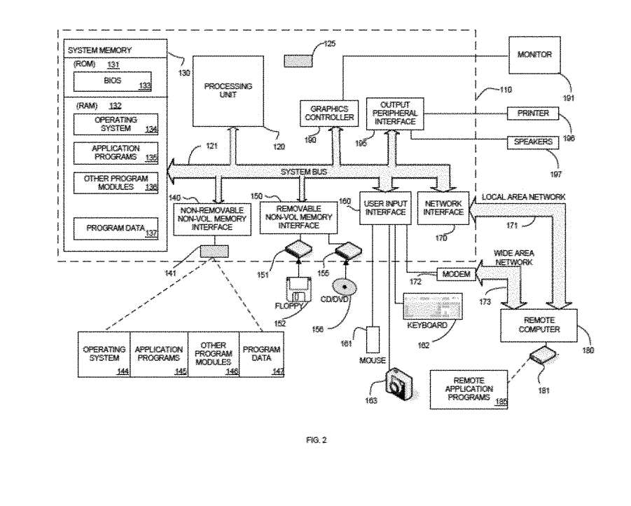

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit has a calculation function that may be used to verify digital signatures, calculate hashes, digitally sign hash values, and encrypt or decrypt data. The cryptographic unit 125 may also have a protected or secure memory for storing keys and other secret data. In addition, the cryptographic unit 125 may include an RNG (random number generator) which is used to provide random numbers. In other embodiments, the functions of the cryptographic unit 125 may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170-172 allow the device to communicate with other devices. The communications connections 170-172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

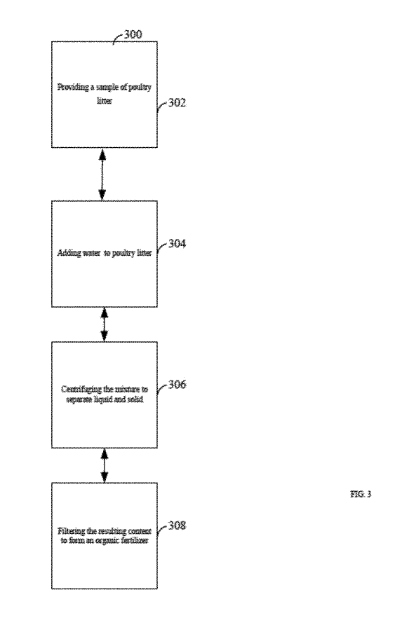

FIG. 3 illustrates a flowchart describing a process 300 in accordance with exemplary embodiments of the invention. At block 302, a sample of poultry litter may be provided. At block 304, water may be added to poultry litter. At block 306, the solution of poultry litter and water may be centrifuged to separate the states into a liquid and a solid. At block 308, the resulting content may be filtered to form an organic fertilizer.

In an embodiment, the method may include: adding water to the poultry litter; mixing the poultry litter in the water; centrifuging the mixture to separate liquid and solid; and filtering the resulting mixture of the water and the samples to form an organic fertilizer. In some embodiments, the method may include: soaking and mixing the poultry litter with water; and applying pressure to the poultry litter to separate liquid and solid.

In another embodiment, the method may include: adding water to the poultry litter soaking; and mixing the poultry litter in the water; centrifuging the mixture to separate liquid and solid; and filtering the resulting content to form an organic fertilizer. This various processes may range from 0-1000 mins or any time duration known by those skilled in the art. In some implementations, the centrifuge may have a size of 0-100 feet tall, 0-100 feet wide, 0-100 feet long.

In yet another embodiment, the final run liquid form of the organic fertilizer may contain nitrogen, phosphate, potassium, ammonium, copper, calcium, magnesium or any material known by those skilled in the art. The quantity of these nutrients or materials in the sample may be determined by WVDA Nutrient Management Lab, Department of Agriculture, State of West Virginia. In some embodiments, the organic fertilizer in final run liquid form may have a moisture of 96.1 percent, a carbon to nitrogen (C:N) ratio of 11.2, and a pH of 6.70. Alternatively, the moisture may have a range of 0-100 percent, a C:N ratio of 0-100, or a range of pH 0-14 or any ranges known by those skilled in the art.

In still another embodiment, the method may include: adding water to the poultry litter; mixing the poultry litter in the water; centrifuging the mixture to separate liquid and solid; and filtering the resulting content to form organic fertilizer in the final run sediment. The final run sediment form of organic fertilizer may contain nitrogen, phosphate, potassium, ammonium, copper, calcium, magnesium, or any material known by those skilled in the art. The quantity of these nutrients or materials in the sample may be determined by WVDA Nutrient Management Lab, Department of Agriculture, State of West Virginia. In some embodiments, the organic fertilizer in final run sediment form may have a moisture of 97.5 percent, a carbon to nitrogen (C:N) ratio of 22.0, and a pH of 6.70.

In some embodiments, the method may include: adding water to the poultry litter; mixing the poultry litter in the water; centrifuging the mixture to separate liquid and solid; and filtering the resulting content to form organic fertilizer in the final left over solid mass. The final left over solid mass of organic fertilizer contains nitrogen, phosphate, potassium, ammonium, copper, calcium, magnesium, or any material known by those skilled in the art. The quantity of these nutrients or materials in the sample may be determined by WVDA Nutrient Management Lab, Department of Agriculture, State of West Virginia. In some embodiments, the organic fertilizer in final left over solid mass may have a moisture of 80.1 percent, a carbon to nitrogen (C:N) ratio of 37.8, and a pH of 7.28.

In another embodiment, the method may include: adding water to the poultry litter; mixing the poultry litter in the water; centrifuging the mixture to separate liquid and solid; and filtering the resulting content to form organic fertilizer in the final left over solid mass. This final left over solid mass of organic fertilizer may be added 50:50 by weight with sawdust. The final solid form of organic fertilizer upon mixing with sawdust may contain nitrogen, phosphate, potassium, ammonium, copper, calcium, magnesium, or any material known by those skilled in the art. The quantity of these nutrients or materials in the sample may be determined by WVDA Nutrient Management Lab, Department of Agriculture, State of West Virginia. In some embodiments, the organic fertilizer in 50:50 mix of final left over solid mass of organic fertilizer with sawdust may have a moisture of 71.2 percent, a carbon to nitrogen (C:N) ratio of 42.2, and a pH of 8.00.

In yet another embodiment, determining the effectiveness of organic fertilizer to supply plant available nutrients, field and laboratory tests may be conducted on their exemplary samples submitted to WVDA Nutrient Management Lab, Department of Agriculture, State of West Virginia. Further, when the samples of organic fertilizer on the surface may be applied in final run liquid form, final run sediment, final left over solid mass, or final left over solid mass combined 50:50 by weight with sawdust, the supplied plant available nitrogen in surface available and incorporated form, phosphate in P2O5 form and potash in K2O form in the quantities can be calculated.

In some implementations, the manufacturing materials may include poultry litter. The poultry litter may include broiler litter, chicken litter, turkey litter or any poultry litter known by those skilled in the art. The poultry litter may be in normal dry form, liquid form, liquid drained off form, liquid pressed form, wet pressed form or any form known to those skilled in the art.

In still another embodiment, the chemical composition of the different forms of broiler litter and turkey litter may be determined from the samples submitted to WVDA Nutrient Management Lab, Department of Agriculture, State of West Virginia. In some embodiments, the dry broiler litter may contain nitrogen, phosphate, potassium, ammonium, copper, calcium, magnesium or any material known by those skilled in the art. The quantity of these nutrients in the sample may be determined by any means known by those skilled in the art In some embodiments, the sample of dry broiler litter may have a moisture of 34.8 percent, a carbon to nitrogen (C:N) ratio of 9.27, and a pH of 8.67.

In yet another embodiment, the sample of dry form of one month old turkey litter may contain nitrogen, phosphate, potassium, ammonium, copper, calcium, magnesium, or any material known by those skilled in the art. The quantity of these nutrients in the sample may be determined by any means known by those skilled in the art. In some embodiments, the sample of turkey litter may have a moisture of 34.03 percent, a carbon to nitrogen (C:N) ratio of 17.62, and a pH of 7.29.

In still another embodiment, the sample of turkey litter may contain nitrogen, phosphate, potassium, ammonium, copper, calcium, magnesium, moisture, or any material known by those skilled in the art. The quantity of these nutrients in the sample may be determined by any means known by those skilled in the art. In some embodiments, the sample of turkey litter may have a moisture 48.0 percent, a carbon to nitrogen (C:N) ratio of 9.72, and a pH of 9.37.

In yet another embodiment, the sample of wet pressed turkey litter may contain nitrogen, phosphate, potassium, ammonium, copper, calcium, magnesium, moisture, or any material known by those skilled in the art. The quantity of these nutrients in the sample may be determined by any means known by those skilled in the art. In some embodiments, the sample of wet pressed turkey litter may have a moisture 74.43 percent, a carbon to nitrogen (C:N) ratio of 15.54, and a pH of 7.84.

In some embodiments, the sample of wet pressed turkey litter may contain nitrogen, phosphate, potassium, ammonium, copper, calcium, magnesium, moisture, or any material known by those skilled in the art. The quantity of these nutrients in the sample may be determined by any means known by those skilled in the art. In some embodiments, the sample of wet pressed turkey litter may have a moisture of 74.5 percent, a carbon to nitrogen (C:N) ratio of 23.9, and a pH of 8.92.

In yet another embodiment, the sample of liquid from pressed turkey litter may contain nitrogen, phosphate, potassium, ammonium, copper, calcium, magnesium, moisture, or any material known by those skilled in the art. The quantity of these nutrients in the sample may be determined by any means known by those skilled in the art. In some embodiments, the sample of liquid from pressed turkey litter may have a moisture 96.40 percent, a carbon to nitrogen (C:N) ratio of 9.45, and a pH of 7.31.

In still another embodiment, the sample of liquid from pressed turkey litter may contain nitrogen, phosphate, potassium, ammonium, copper, calcium, magnesium, moisture or any material known by those skilled in the art. The quantity of these nutrients in the sample may be determined by any means known by those skilled in the art. In some embodiments, the sample of liquid from pressed turkey litter may have a moisture of 96.13 percent, a carbon to nitrogen (C:N) ratio of 6.20, and a pH of 8.79.

In some implementations, the effectiveness of various forms of broiler litter and turkey litter to supply plant available nutrients may be analyzed by conducting field and laboratory tests on the samples submitted to WVDA Nutrient Management Lab, Department of Agriculture, State of West Virginia.

In another embodiment, when the samples of dry broiler litter, dry form of one month old turkey litter, turkey litter, final run sediment, wet pressed turkey litter, or liquid from pressed turkey litter, may be supplied plant available nitrogen in surface available and incorporated form, phosphate in P2O5 form and potash in K2O form in the quantities may be calculated.

In still another embodiment, the system may include the out of the final run liquid form and final sediment form, the final run liquid form of the organic fertilizer provides more plant available nitrogen (surface available), nitrogen (incorporated), phosphate (P2O5) and potash (K2O) when may be applied to the surface. Furthermore, the final run liquid form of the organic fertilizer when surface applied may provide plant available nitrogen (surface available), nitrogen (incorporated), phosphate (P2O5) and potash (K2O) comparable to the plant available nitrogen (surface available), nitrogen (incorporated), phosphate (P2O5) and potash (K2O) provided by surface application of the liquid from pressed turkey litter.

In yet another embodiment, the system may include both final solid form of the organic fertilizer and final solid form of the organic fertilizer mixed with sawdust, and may provide similar quantities of plant available nitrogen (incorporated), phosphate (P2O5) and potash (K2O) when surface applied. The final solid form of the organic fertilizer mixed with sawdust may provide a little more plant available nitrogen (surface available) compared to the plant available nitrogen (surface available) provided by the final solid form of the organic fertilizer when surface applied alone. Additionally, both final solid form of the organic fertilizer and final solid form of the organic fertilizer mixed with sawdust, when surface applied may provide lesser quantities of plant available nitrogen (incorporated), phosphate (P2O5) and potash (K2O) compared to the plant available nitrogen (surface available), nitrogen (incorporated), phosphate (P2O5) and potash (K2O) provided by surface application of the liquid from pressed turkey litter. This may be useful for preventing pollutants runoff to groundwater when raw poultry litter is applied to the plants as the content of these minerals is higher in raw poultry litter compared to the plant's requirement for these minerals.

In some embodiments, the broiler litter can be used in different forms such as normal form, liquid form, fresh dry form, liquid drain off form, liquid pressed form, wet pressed form for producing the organic fertilizer or any form known by those skilled in the art. The fresh dry form of broiler litter may contain maximum nitrogen and low or high quantity of phosphate in relation to the form of litter.

In another embodiment, the organic fertilizer produced from the poultry litter may provide good plant nutrition when applied to the crop field. The organic fertilizer may provide an environmentally safer fertilizer than many commercially available products commonly used in urban and agricultural systems. The final run liquid form of the organic fertilizer may lack any weed or seed which may be present in the poultry litter used to produce the organic fertilizers. As a result, the final run liquid form of the organic fertilizer when applied may not need weedicide to kill any weeds introduced by other fertilizer. It also may not cause water pollution due to weedicides and other pollutants runoff to water body. The final run liquid form of the organic fertilizer can be packaged in tankers, barrels, bucket or any container known by those skilled in the art. It can be applied by hand pump, sprayer, put in form of mulch, or any means known by those skilled in the art. The method used to prepare the organic fertilizer from the poultry litter may also capture clean gas for fuel. In some implementations, the organic fertilizer may be used on a roof top garden, a hillside garden, green houses, nursery, farms, lawns or any surface known by those skilled in the art.

In an embodiment, the system may include: a sample providing device to provide one or more samples of poultry litter; a mixer to mix the samples of poultry litter with water; a centrifuge device to centrifuge the mixture of the water and the samples to separate the mixture into a liquid component and a solid component; and a filter for filtering a resulting mixture of the water and the samples to form an organic fertilizer. The system may also include a soaking device to soak the poultry litter with water.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A method for producing organic fertilizer from poultry litter comprising:
providing one or more samples of poultry litter;
mixing the samples of poultry litter with water;
centrifuging the mixture of the water and the samples to separate the mixture into a liquid component and a solid component; and
filtering a resulting mixture of the water and the samples to form an organic fertilizer.

2. The method of claim 1, further comprising: soaking the poultry litter with the water.

3. The method of claim 1, wherein the organic fertilizer is in a final run liquid form.

4. The method of claim 1, wherein the organic fertilizer is in a final run sediment form.

5. The method of claim 1, wherein the organic fertilizer is in a final left over solid mass form.

6. The method of claim 1, wherein the poultry litter is broiler litter.

7. The method of claim 1, wherein the poultry litter is turkey litter.

8. The method of claim 1, wherein the poultry litter is in a normal dry form.

9. A system for producing organic fertilizer from poultry litter comprising:
a sample providing device to provide one or more samples of poultry litter;
a mixer to mix the samples of poultry litter with water;
a centrifuge device to centrifuge the mixture of the water and the samples to separate the mixture into a liquid component and a solid component; and
a filter for filtering a resulting mixture of the water and the samples to form an organic fertilizer.

10. The system of claim 9, further comprising: a soaking device to soak the poultry litter with the water.

11. The system of claim 9, wherein the organic fertilizer is in a final run liquid form.

12. The system of claim 9, wherein the organic fertilizer is in a final run sediment form.

13. The system of claim 12, wherein the organic fertilizer is in a final left over solid mass form.

14. The system of claim 9, wherein the poultry litter is broiler litter.

15. A means for producing organic fertilizer from poultry litter comprising:
a means for analyzing one or more samples of poultry litter;
a means for mixing the samples of poultry litter with water;
a means for centrifuging the mixture of the water and the samples; and
a means for filtering a resulting mixture of the water and the samples.

16. The means of claim 15, further comprising: a means for soaking the poultry litter with the water.

17. The means of claim 15, wherein the organic fertilizer is in a final run liquid form.

18. The means of claim 15, wherein the organic fertilizer is in a final run sediment form.

19. The means of claim 15, wherein the organic fertilizer is in a final left over solid mass form.

20. The means of claim 15, wherein the poultry litter is broiler litter.
